(19) United States
(12) Patent Application Publication
(10) Pub. No.: US 2015/0225023 A1
(43) Pub. Date: Aug. 13, 2015

(54) ONE-PIECE POLYMERIC COMPOSITE RAFTER

(71) Applicant: CPI Binani, INC., Winona, MN (US)

(72) Inventors: Ronald C. Hawley, Winona, MN (US); Darin J. Grinsteinner, Holmen, WI (US); Larry E. Tiedermann, Winona, WI (US)

(73) Assignee: CPI Binani, INC., Wiinona, MN (US)

(21) Appl. No.: 14/415,646

(22) PCT Filed: Jul. 25, 2013
(86) PCT No.: PCT/US2013/051944

§ 371 Date: Jan. 19, 2015

Related U.S. Application Data
(60) Provisional application No. 61/676,722, filed on Jul. 27, 2012.

(51) Int. Cl. B62D 29/04; B62D 25/06; B29C 43/18

(52) U.S. Cl. CPC B62D 29/043; B29C 43/18; B62D 25/06; B29K 2023/00

(57) ABSTRACT

A one-piece polymeric composite rafter, a method of forming a one-piece polymeric composite rafter and a vehicle that includes the one-piece polymeric composite rafter. The one-piece polymeric composite rafter includes a first elongate beam, a second elongate beam, a first fastening portion having a first ledge projecting between a first end wall of the first elongate beam and a first end wall of the second elongate beam, where the first fastening portion projects longitudinally beyond the first end of the first elongate beam towards the first end of the second elongate beam; and a second fastening portion having a second ledge projecting between a second end wall of the first elongate beam and a second end wall of the second elongate beam, where the second fastening portion projects longitudinally beyond the second end of the first elongate beam towards the second end of the second elongate beam.

This application claims the benefit of U.S. Provisional Application No. 61/676,722 filed Jul. 27, 2012, the entire content of which is incorporated herein by reference.

### FIELD OF THE DISCLOSURE

The disclosure is directed to a rafter, and more particularly to a one-piece polymeric composite rafter for a vehicle.

### SUMMARY

The present disclosure provides for a one-piece polymeric composite rafter formed from a polymeric composite material. The one-piece polymeric composite rafter includes a first elongate beam, a second elongate beam, a first fastening portion and a second fastening portion, where these portions are formed as the one-piece polymeric composite rafter from a polymeric composite material having 47 weight percent (wt. %) to 89.5 wt. % of a polyolefin, 10 wt. % to 50 wt. % of a long glass fiber reinforcement, and 0.5 wt. % to 3 wt. % of a coupling agent coupling the long glass fiber reinforcement to the polyolefin, wherein the wt. % values of the polymeric composite material are based on a total weight of the polymeric composite material and total to a value of 100 wt. %.

For the various embodiments, the first elongate beam has a first end and a second end, where the first end includes a first end wall and the second end includes a second end wall. The second elongate beam has a first end adjacent the first end of the first elongate beam and a second end adjacent the second end of the first elongate beam, where the first end includes a first end wall and the second end includes a second end wall. The first fastening portion has a first ledge projecting between the first end wall of the first elongate beam and the first end wall of the second elongate beam, where the first fastening portion projects longitudinally beyond the first end of the first elongate beam towards the first end of the second elongate beam. The first fastening portion can include a first series of ribs in which each rib projects in a direction between the first elongate beam and the first ledge. The second fastening portion has a second ledge projecting between the second end wall of the first elongate beam and the second end wall of the second elongate beam, where the second fastening portion projects longitudinally beyond the second end of the first elongate beam towards the second end of the second elongate beam. The second fastening portion can include a second series of ribs in which each rib projects in a direction between the first elongate beam and the second ledge. The first series of ribs and the second series of ribs are adapted to receive and secure a fastener.

The present disclosure also provides a method of forming the one-piece polymeric composite rafter that includes extruding a polymeric composite material and molding the polymeric composite material in a cavity of a mold to form the one-piece polymeric composite rafter. As discussed herein, the one-piece polymeric composite rafter has a first elongate beam with a first end and a second end, where the first end includes a first end wall and the second end includes a second end wall; a second elongate beam having a first end adjacent the first end of the first elongate beam and a second end adjacent the second end of the first elongate beam, where the first end includes a first end wall and the second end includes a second end wall; a first fastening portion having a first ledge projecting between the first end wall of the first elongate beam and the first end wall of the second elongate beam, and a first series of ribs in which each rib projects in a direction between the first elongate beam and the first ledge, where the first fastening portion projects longitudinally beyond the first end of the first elongate beam towards the first end of the second elongate beam; and a second fastening portion having a second ledge projecting between the second end wail of the first elongate beam and the second end wall of the second elongate beam, and a second series of ribs in which each rib projects in a direction between the first elongate beam and the second ledge, where the second fastening portion projects longitudinally beyond the second end of the first elongate beam towards the second end of the second elongate beam, where the first series of ribs and the second series of ribs are adapted to receive and secure a fastener.

### BRIEF DESCRIPTION OF THE DRAWING

The drawings may not be to scale.

FIG. 1A is a perspective view of a first side of a one-piece polymeric composite rafter according to one embodiment of the present disclosure.

FIG. 1B is a perspective view of a second side of the one-piece polymeric composite rafter illustrated in FIG. 1A according to one embodiment of the present disclosure.

FIG. 2A is a perspective view of a first side of a one-piece polymeric composite rafter according to one embodiment of the present disclosure.

FIG. 2B is a perspective view of a second side of the one-piece polymeric composite rafter illustrated in FIG. 2A according to one embodiment of the present disclosure.

FIG. 3 is a perspective view of a first fastening portion of the one-piece polymeric composite rafter according to the embodiment illustrated in FIG. 2A of the present disclosure.

FIG. 4A is a perspective view of a first side of a one-piece polymeric composite rafter according to one embodiment of the present disclosure.

FIG. 4B is a perspective view of a second side of the one-piece polymeric composite rafter illustrated in FIG. 4A according to one embodiment of the present disclosure.

FIG. 5 is a perspective view of a first fastening portion of the one-piece polymeric composite rafter according to one embodiment of the one-piece polymeric composite rafter illustrated in FIG. 4A of the present disclosure.

FIG. 6 is a perspective view of a first fastening portion of the one-piece polymeric composite rafter according to one embodiment of the one-piece polymeric composite rafter illustrated in FIG. 4A of the present disclosure.

FIG. 7 is a planar view of a one-piece polymeric composite rafter according to one embodiment of the present disclosure.

FIG. 8 is a perspective view of a vehicle that includes a one-piece polymeric composite rafter of the present disclosure.

FIG. 9 is a perspective view of a vehicle that includes a one-piece polymeric composite rafter of the present disclosure.

### DEFINITIONS

As used herein a “vehicle” is a device that is designed or used to transport people and/or cargo, where the vehicle can include a one-piece polymeric composite rafter of the present disclosure to support a roof of the vehicle.

As used herein, a polyolefin refers to a polymer formed from an olefin, which can be an acyclic and/or a cyclic hydrocarbon each having one or more carbon-carbon double bonds, apart from the formal ones in aromatic compounds.

As used herein, a flame retardant is a compound that is used to inhibit or resist the spread of fire.

As used herein, the term “specific strength” refers to a material's strength (force per unit area at failure) divided by its density. It is also known as the strength-to-weight ratio or strength/weight ratio.

As used herein, the term “specific stiffness” refers to a materials property consisting of the elastic modulus per mass density of a material. It is also known as the stiffness to weight ratio or specific stiffness.

As used herein, the phrase “melt flow index” is a measure of the ease of flow of the melt of a thermoplastic polymer. It is defined as the mass of polymer, in grams, flowing in ten minutes through a capillary of a specific diameter and length by a pressure applied via prescribed alternative gravimetric weights'for alternative prescribed temperatures according to ASTM D1238.

As used herein, an “aspect ratio” is the proportional relationship between the diameter of a fiber and its length.

As used herein, transfer molding is a process where the amount of a molding material (e.g., the polymeric composite material of the present disclosure) is measured and inserted into a compression mold before molding under pressure takes place.

As used herein, a direct long fiber thermoplastic process provides for continuous feeding of glass-fiber rovings into a screw extruder containing a polyolefin composition in a molten state, where the glass-fiber rovings and the polyolefin form a composite material that is either processed by compression molding or injection molding.

As used herein, the abbreviation “cm” stands for centimeter.

As used herein, the abbreviation “mm” stands for millimeter.

As used herein, the abbreviation “in” stands for inch(es).

As provided herein the weight percent (wt. %) values of the polymeric composite material of the embodiments provided herein are based on a total weight of the polymeric composite material, where the weight percents of the components (e.g., the polyolefin, the long glass fiber reinforcement, the coupling agent, and, optionally, a flame retardant and/or a filler) used in forming the polymeric composite material total to a value of 100 wt. %.

### DETAILED DESCRIPTION

The present disclosure is directed to a one-piece polymeric composite rafter for use in a variety of vehicles. Such vehicles can include, but are not limited to, trailers, pop-up campers, travel trailers, recreational vehicles and vans (e.g. “custom” vans), among others. The one-piece polymeric composite rafter of the present disclosure provides a solution to the problem of variability in the distance (i.e., width) between the vertical walls of the vehicle. Specifically, the one-piece polymeric composite rafter of the present disclosure can be modified so as to allow the one-piece polymeric composite rafter to be joined to the vertical walls while allowing the vertical walls to maintain their desired location and relative position.

The one-piece polymeric composite rafter is also formed of a polymeric composite material. The polymeric composite material has a hardness that allows fasteners to be secured along the one-piece polymeric composite rafter. Embodiments of the one-piece polymeric composite rafter also include a first fastening portion and a second fastening portion that can receive and firmly hold a fastener (e.g., a screw and/or nail). The one-piece polymeric composite rafter of the present disclosure can also provide for a curved roof structure and/or a curved ceiling structure for the vehicle, which can add to the overall aesthetics and interior volume of the vehicle.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process and/or structural changes may be made without departing from the scope of the present disclosure.

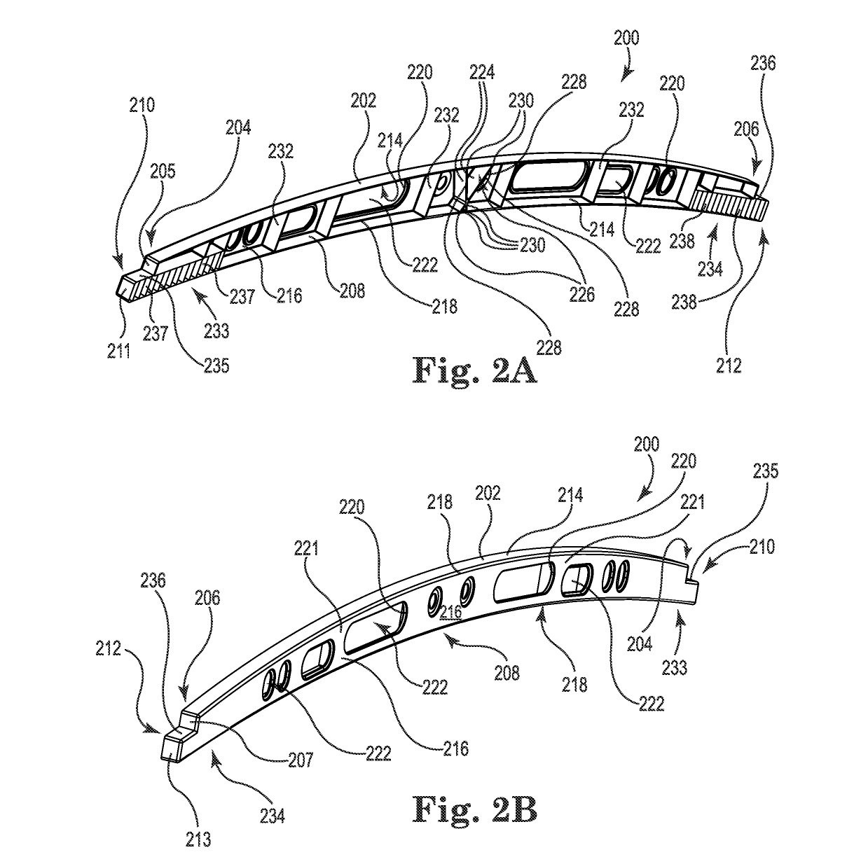

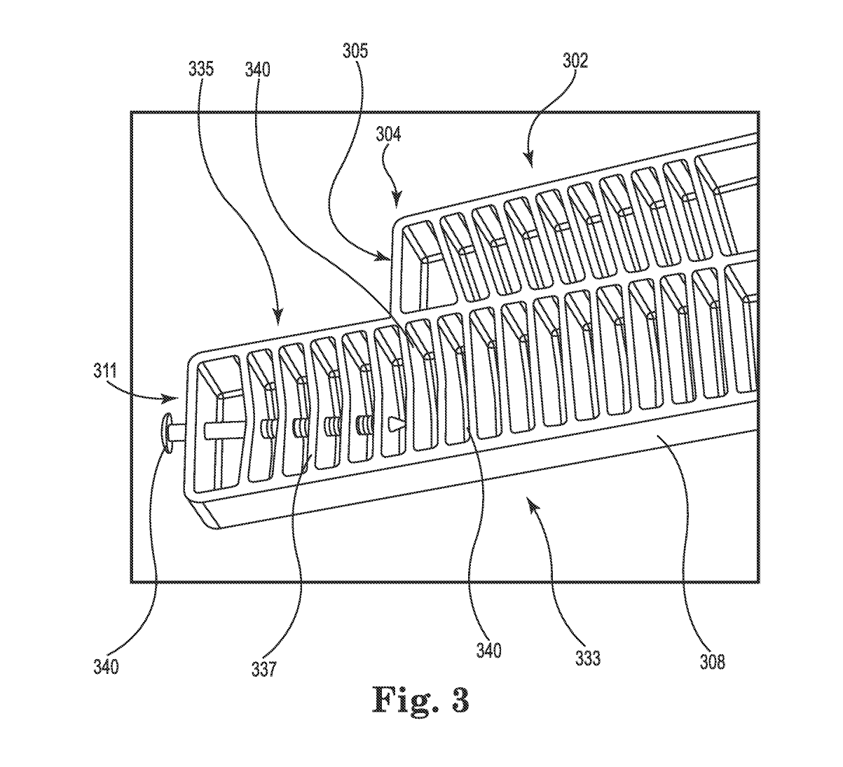

The figures herein follow a numbering convention in which the first digit or digits correspond to the drawing figure number and the remaining digits identify an element or component in the drawing. Similar elements or components between different figures may be identified by the use of similar digits. For example, 214 may reference element “14” in FIG. 2, and a similar element may be referenced as 314 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

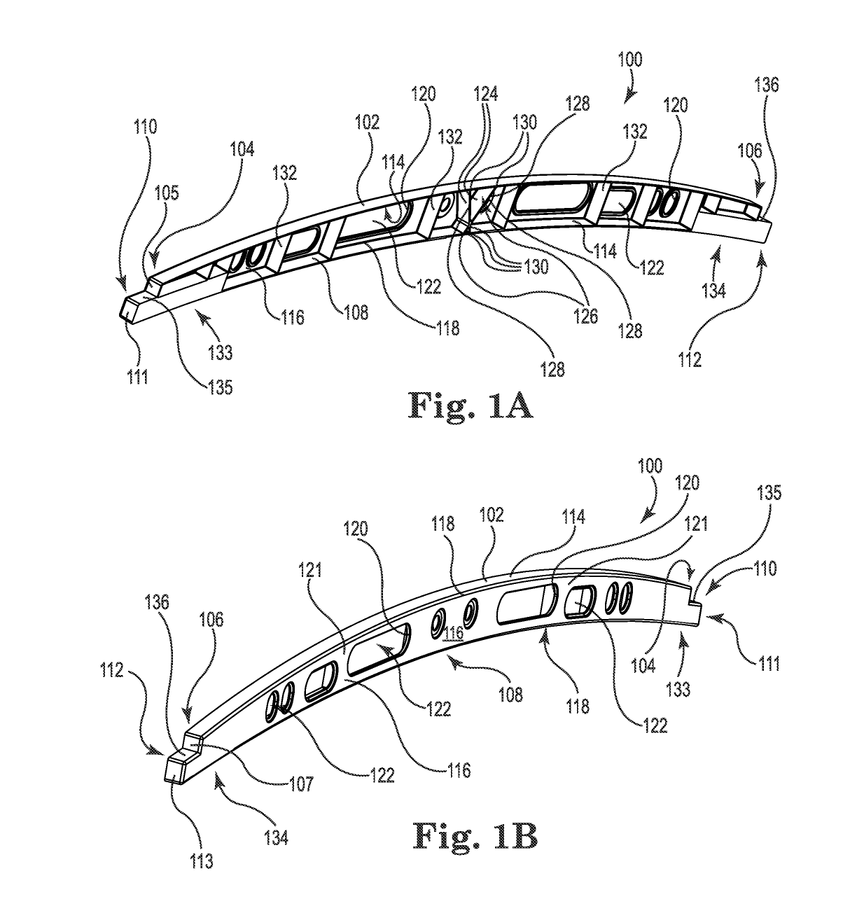

FIGS. 1A and 1B provides two perspective views of an example of a one-piece polymeric composite rafter 100 according to the present disclosure. As illustrated, the one-piece polymeric composite rafter 100 includes structural components formed from a polymeric composite material, as discussed herein, that allow for a combination of light weight and high strength that is adaptable to meet the physical constrains of the vertical wall structure of the vehicle, as will be discussed more fully herein.

The one-piece polymeric composite rafter 100 includes a first elongate beam 102 of the polymeric composite material, the first elongate beam 102 having a first end 104 and a second end 106. The first end 104 includes a first end wall 105 and the second end 106 includes a second end wall 107. The one-piece polymeric composite rafter 100 further includes a second elongate beam 108 of the polymeric composite material, the second elongate beam 108 having a first end 110 adjacent the first end 104 of the first elongate beam 102 and a second end 112 adjacent the second end 106 of the first elongate beam 102. The first end 110 includes a first end wall 111 and the second end 112 includes a second end wall 113.

As illustrated, the first elongate beam 102 and the second elongate beam 108 can each include a flange 114 that projects from a web 116. The web 116 can help to resists shear forces while the flanges 114 can help to resist the bending moment experienced by the one-piece polymeric composite rafter 100. As illustrated, the first elongate beam 102, the second elongate beam 108 and the web 116 create a “C-beam” shape, where the web 116 projects from the edge 118, running in the longitudinal direction of the one-piece polymeric composite rafter 100, of each of the flanges 114. As illustrated, the planar surface 121 defines an outer most portion of the perimeter of the one-piece polymeric composite rafter 100.

The web 116 of the one-piece polymeric composite rafter 100 further includes surfaces 120 defining openings 122 that pass through the web 116. The openings 122 allows for a variety of structures to pass through the one-piece polymeric composite rafter 100. For example, electrical wiring, plumbing, heating and cooling ducts, communication wiring, etc. can be passed through the openings 122 of the one-piece polymeric composite rafter 100. As illustrated, the openings 122 have tapered edges and curved ends so as to better reduce the chances of snagging and/or tearing the coverings and/or insulation on the electrical wiring, plumbing, heating and cooling ducts and/or communication wiring that are pulled through the openings 122.

The one-piece polymeric composite rafter 100 further includes a truss structure 124 joining the first elongate beam 102 and the second elongate beam 108. The truss structure 124 provides one or more triangular units 126 constructed with truss members 128 whose ends are connected at nodes 130. It is appreciated that two or more truss structures 124 could be used in the one-piece polymeric composite rafter 100. The one-piece polymeric composite rafter 100 also includes straight members 132 that project between the first elongate beam 102, the second elongate beam 108 and the web 116, where the straight members 132 are either integral with or attached to the beams 102, 108 and the web 116.

The one-piece polymeric composite rafter 100 further includes a first fastening portion 133 and a second fastening portion 134. The first fastening portion 133 includes a first ledge 135 projecting between the first end wall 105 of the first elongate beam 102 and the first end wall 111 of the second elongate beam 108. The first fastening portion 133 projects longitudinally beyond the first end 104 of the first elongate beam 102 towards the first end 110 of the second elongate beam 108. The second fastening portion 134 includes a second ledge 136 that projects between the second end wall 107 of the first elongate beam 102 and the second end wall 113 of the second elongate beam 108. The second fastening portion 134 projects longitudinally beyond the second end 106 of the first elongate beam 102 towards the second end 112 of the second elongate beam 108.

Referring now to FIGS. 2A and 2B there is shown two perspective views of another embodiment of the one-piece polymeric composite rafter 200 formed from the polymeric composite material. As illustrated, the one-piece polymeric composite rafter 200 includes structural components formed from the polymeric composite material, discussed herein, that allow for a combination of light weight and high strength that is adaptable to meet the physical constrains of the vertical wall structure of the vehicle.

The one-piece polymeric composite rafter 200 includes the first elongate beam 202 of the polymeric composite material, the first elongate beam 202 having the first end 204 and the second end 206. The first end 204 includes the first end wall 205 and the second end 206 includes the second end wall 207. The one-piece polymeric composite rafter 200 further includes the second elongate beam 208 of the polymeric composite material, the second elongate beam 208 having the first end 210 adjacent the first end 204 of the first elongate beam 202 and the second end 212 adjacent the second end 206 of the first elongate beam 202. The first end 210 includes the first end wall 211 and the second end 212 includes the second end wall 213.

As illustrated, the first elongate beam 202 and the second elongate beam 208 can each include a flange 214 that projects from the web 216. The web 216 helps to resists shear forces while the flanges 214 can help to resist the bending moment experienced by the one-piece polymeric composite rafter 200. As illustrated, the first elongate beam 202, the second elongate beam 208 and the web 216 create a “C-beam” shape, where the web 216 projects from the edge 218, running in the longitudinal direction of the one-piece polymeric composite rafter 200, of each of the flanges 214. As illustrated, the planar surface 221 defines an outer most portion of the perimeter of the one-piece polymeric composite rafter 200.

The web 216 of the one-piece polymeric composite rafter 200 further includes surfaces 220 defining the openings 222 that pass through the web 216. The one-piece polymeric composite rafter 200 further includes the truss structure 224 having one or more triangular units 226 and nodes 230 that join the first elongate beam 202 and the second elongate beam 208. The one-piece polymeric composite rafter 200 also includes straight members 232 that project between the first elongate beam 202, the second elongate beam 208 and the web 216, where the straight members 232 are either integral with or attached to the beams 202, 208 and the web 216.

The one-piece polymeric composite rafter 200 further includes the first fastening portion 233 and the second fastening portion 234. The first fastening portion 233 includes the first ledge 235 projecting between the first end wall 205 of the first elongate beam 202 and the first end wall 211 of the second elongate beam 208. The first fastening portion 233 projects longitudinally beyond the first end 204 of the first elongate beam 202 towards the first end 210 of the second elongate beam 208. The first fastening portion 233 further includes a first series of ribs 237. As illustrated, each rib of the first series of ribs 237 projects in a direction between the first elongate beam 202 and the first ledge 235. The first series of ribs 237 are integral with (e.g., formed as one-piece from the polymeric composite material) the beam 208 and the first ledge 235. Each rib of the first series of ribs 237 can also be separated by a predefined interval. For this embodiment, the predefined interval can be measured on center along the longitudinal axis of a pair of adjacent ribs. It is also possible for the ribs of the first series of ribs 237 to have a non-uniform spacing between pairs of adjacent ribs.

The second fastening portion 234 includes a second ledge 236 that projects between the second end wall 207 of the first elongate beam 202 and the second end wall 213 of the second elongate beam 208. The second fastening portion 234 projects longitudinally beyond the second end 206 of the first elongate beam 202 towards the second end 212 of the second elongate beam 208. The second fastening portion 234 further includes a second series of ribs 238. As illustrated, each rib of the second series of ribs 238 projects in a direction between the first elongate beam 202 and the second ledge 236. The second series of ribs 238 are integral with (e.g., formed as one-piece from the polymeric composite material) the beam 208 and the second ledge 236. Each rib of the second series of ribs 238 can also be separated by a predefined interval. For this embodiment, the predefined interval can be measured on center along the longitudinal axis of a pair of adjacent ribs. It is also possible for the ribs of the second series of ribs 238 to have a non-uniform spacing between pairs of adjacent ribs.

For the various embodiments, the predefined interval separating each of the ribs of the first series of ribs 237 and/or the second series of ribs 238 can have a value of 0.1 inches to 1 inch. The first series of ribs 237 and the second series of ribs 238 are adapted to receive and secure a fastener, as discussed herein. The first series of ribs 237 and the second series of ribs 238 can also help to provide strength to the one-piece polymeric composite rafter 200. In addition to providing strength, the series of ribs can also help to grip and secure a fastener received by the ribs. The ribs can also flex in counteracting force applied to a fastener that has been received by the ribs. This allows the faster and the ribs to maintain relative position once the force is stopped. In other words, the ribs help hold the fastener.

Referring now to FIG. 3, there is shown an enlarged view of the first series of ribs 333 formed from the polymeric composite material. The discussion for the first series of ribs 333 is applicable to the second series of ribs, which are not shown in FIG. 3, but will be referenced in the following discussion. As illustrated, each rib of the first series of ribs 337 and/or the second series of ribs include major surfaces 340 that are parallel to the major surfaces 340 on one or more adjacent ribs. This embodiment is illustrated in FIG. 3. Alternatively, the major surfaces 340 of one or more of the ribs have a non-parallel relationship to one or more of the other ribs of the series of ribs.

FIG. 3 also provides an illustration where the first series of ribs 337 in the first fastening portion 333 extend (e.g., to enlarge the area of) longitudinally from the first end 304 of the first elongate beam 302 towards the second end of the first elongate beam 302. Similarly, the second series of ribs in the second fastening portion extend (e.g., to enlarge the area of) longitudinally from the second end of the first elongate beam towards the first end of the first elongate beam. FIG. 3 also provides an illustration of a fastener 340 that has been received by the ribs 337.

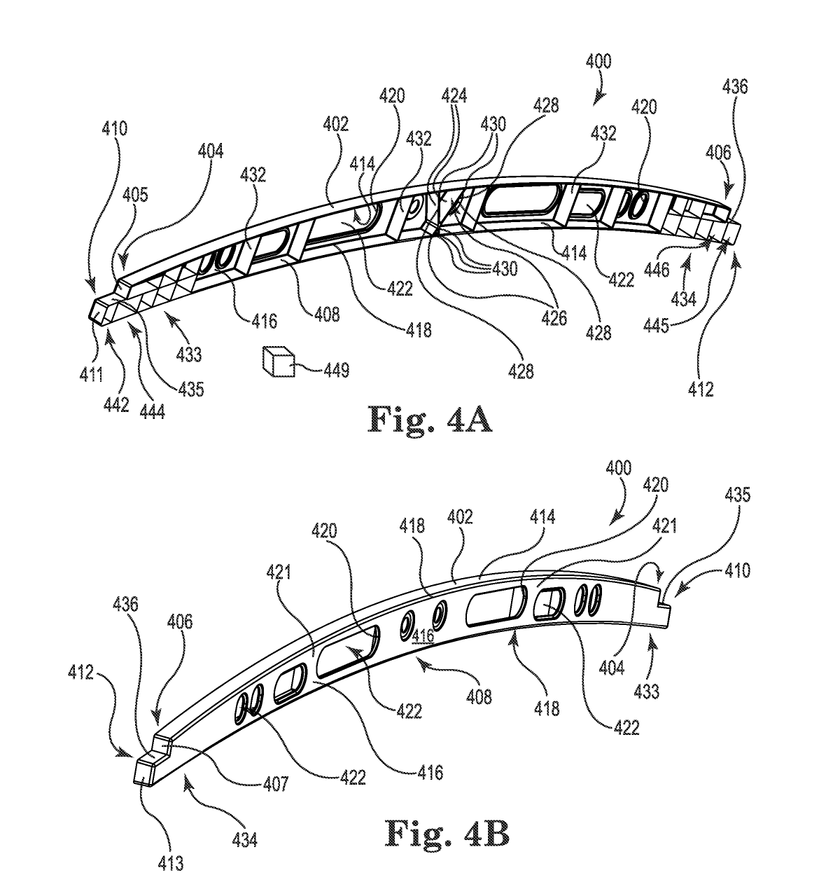

Referring now to FIGS. 4A and 4B, there is shown two perspective views of another embodiment of the one-piece polymeric composite rafter 400 formed from the polymeric composite material. As illustrated, the one-piece polymeric composite rafter 400 includes structural components formed from the polymeric composite material, discussed herein, that allow for a combination of light weight and high strength that is adaptable to meet the physical constrains of the vertical wall structure of the vehicle.

The one-piece polymeric composite rafter 400 includes the first elongate beam 402 of the polymeric composite material, the first elongate beam 402 having the first end 404 and the second end 406. The first end 404 includes the first end wall 405 and the second end 406 includes the second end wall 407. The one-piece polymeric composite rafter 400 further includes the second elongate beam 408 of the polymeric composite material, the second elongate beam 408 having the first end 410 adjacent the first end 404 of the first elongate beam 402 and the second end 412 adjacent the second end 406 of the first elongate beam 402. The first end 410 includes the first end wall 411 and the second end 412 includes the second end wall 413.

As illustrated, the first elongate beam 402 and the second elongate beam 408 can each include a flange 414 that projects from the web 416. As illustrated, the first elongate beam 402, the second elongate beam 408 and the web 416 create a “C-beam” shape, where the web 416 projects from the edge 418, running in the longitudinal direction of the one-piece polymeric composite rafter 400, of each of the flanges 414. The web 416 helps to resists shear forces while the flanges 414 can help to resist the bending moment experienced by the one-piece polymeric composite rafter 400. As illustrated, the planar surface 421 defines an outer most portion of the perimeter of the one-piece polymeric composite rafter 400.

The web 416 of the one-piece polymeric composite rafter 400 further includes surfaces 420 defining the openings 422 that pass through the web 416. The one-piece polymeric composite rafter 400 further includes the truss structure 424 having one or more triangular units 426 and nodes 430 that join the first elongate beam 402 and the second elongate beam 408. The one-piece polymeric composite rafter 400 also includes straight members 432 that project between the first elongate beam 402, the second elongate beam 408 and the web 416, where the straight members 432 are either integral with or attached to the beams 402, 408 and the web 416.

The one-piece polymeric composite rafter 400 further includes the first fastening portion 433 and the second fastening portion 434. The first fastening portion 433 includes the first ledge 435 projecting between the first end wall 405 of the first elongate beam 402 and the first end wall 411 of the second elongate beam 408. The first fastening portion 433 projects longitudinally beyond the first end 404 of the first elongate beam 402 towards the first end 410 of the second elongate beam 408. The first fastening portion 433 further includes a first series of ribs 437. As illustrated, each rib of the first series of ribs 437 projects in a direction between the first elongate beam 402 and the first ledge 435. The first series of ribs 437 are integral with (e.g., formed as one-piece from the polymeric composite material) the beam 408 and the first ledge 435. Each rib of the first series of ribs 437 can also be separated by a predefined interval. For this embodiment, the predefined interval can be measured on center along the longitudinal axis of a pair of adjacent ribs. It is also possible for the ribs of the first series of ribs 437 to have a non-uniform spacing between pairs of adjacent ribs.

The first fastening portion 433 also includes a socket 442 defined at least in part by the first end wall 411 of the second elongate beam 408, at least a portion of the first ledge 435, at least a portion of the second elongate beam 408 and at least one rib of the first series of ribs 437. In addition, the first fastening portion 433 can also include a second socket 444 defined at least in part by two ribs of the first series of ribs 437, at least a portion of the second elongate beam 408 and at least a portion of the first ledge 435.

The second fastening portion 434 further includes the second series of ribs 438. As illustrated, each rib of the second series of ribs 438 projects in a direction between the first elongate beam 402 and the second ledge 436. The second series of ribs 438 are integral with (e.g., formed as one-piece from the polymeric composite material) the beam 408 and the second ledge 436. Each rib of the second series of ribs 438 can also be separated by a predefined interval. For this embodiment, the predefined interval can be measured on center along the longitudinal axis of a pair of adjacent ribs. It is also possible for the ribs of the second series of ribs 438 to have a non-uniform spacing between pairs of adjacent ribs.

The second fastening portion 434 includes the second ledge 436 that projects between the second end wall 407 of the first elongate beam 402 and the second end wall 413 of the second elongate beam 408. The second fastening portion 434 projects longitudinally beyond the second end 406 of the first elongate beam 402 towards the second end 412 of the second elongate beam 408. The second fastening portion 434 includes a socket 445 defined at least in part by the second end wall 407 of the second elongate beam 408, at least a portion of the second ledge 436, at least a portion of the second elongate beam 408 and at least one rib of the second series of ribs 438. The second fastening portion 434 also includes a second socket 446 defined at least in part by two ribs of the second series of ribs 438, at least a portion of the second elongate beam 408 and at least a portion of the second ledge 436.

The socket (e.g., 442, 444, 445 and/or 446) can receive a block of material 449. The block of material 449 can be sized relative the socket (e.g., 442, 444, 445 and/or 446) to allow for a friction fit in the socket. In one embodiment, the block of material 449 can be inserted into the socket (e.g., 442, 444, 445 and/or 446) during the manufacturing process, discussed herein, before the polymeric composite material cools to ambient temperature. An adhesive can also be used to secure the block of material 449 in the socket (e.g., 442, 444, 445 and/or 446). Examples of such adhesives include, but are not limited to, those from natural or synthetic sources. Examples of such adhesives include, but are not limited to, epoxy, polyurethane, cyanoacrylate and acrylic polymer based adhesives.

The block of material 449 can be formed from a wide variety of materials. In addition, the block of material 449 can have a variety of shapes and configurations. Examples of such materials include, but are not limited to, cellulose based materials (e.g., wood), the polymeric composite material of the present disclosure, thermoplastic materials (e.g., polyethylene's of varying densities, nylon polymers, acetal, and reinforced or filled thermoplastic materials, among others), thermoset materials (e.g., polyesters, vinyl esters, epoxies, elastomers, reinforced or filled thermoplastics, among others), and rigid foam materials (e.g., polyurethanes of varying densities, polystyrene, polyurethane/polyethylene blends, among others).

Examples of cellulose based materials can include engineered wood products made by binding strands, particles, fibers, and/or veneers of wood, together with adhesives, to form the engineered wood product. Examples include plywood, oriented strand board, glued laminated timber, laminated veneer lumber and oriented strand lumber, among others. Other types of wood are possible, and include, but are not limited to, balsa wood, bamboo, #2 pine, and compressed corrugated material, among others. Examples of thermoplastic materials can include, but are not limited to, a polyolefin, a polyamide, a polyester, a polyurethane, an acrylonitrile, a butadiene styrene, a polycarbonate, a polystyrene, among others. Copolymers, terpolymers, and blends of these polymers may also be used.

The shapes and configuration of the block of material 449 can include a solid block of the material, a hollow block where the material forms the walls that define the hollow block, and a semi-hollow block where the material forms walls and rib structures that define the semi-hollow block configuration. The shape of the block of material 449 can allow for a friction fit of the block of material 449 in the socket (e.g., 442, 444, 445 and/or 446). For the various embodiments, at least two peripheral surfaces of the block (e.g., 442, 444, 445 and/or 446) can have the friction fit with the walls of the socket (e.g., 442, 444, 445 and/or 446). The block of material 449 need not touch all the walls (e.g., the ribs, end walls and/or ledges) that define the socket (e.g., 442, 444, 445 and/or 446).

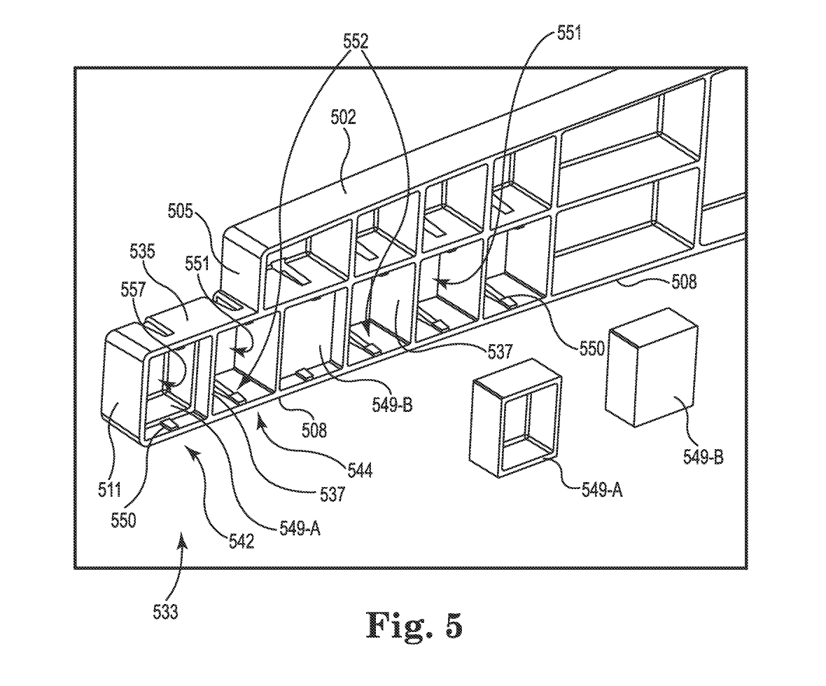

Referring now to FIG. 5, there is shown an enlarged view of the first fastening portion 533 having the socket 542 and 544, as discussed herein. The discussion for the first fastening portion 533 and the sockets 542 and 544 is applicable to the second fastening portion and its sockets, which are not shown in FIG. 5, but will be referenced in the following discussion. As illustrated, the socket 542 is defined at least in part by the first end wall 511 of the second elongate beam 508, at least a portion of the first ledge 535, at least a portion of the second elongate beam 508 and at least one rib of the first series of ribs 537. The second socket 544 is defined at least in part by two ribs of the first series of ribs 537, at least a portion of the second elongate beam 508 and at least a portion of the first ledge 535. The block of material 549 is shown in FIG. 5 as both a hollow block (549-A) where the material forms the walls that define the hollow block configuration and as a solid block configuration (549-B).

The embodiment illustrated in FIG. 5 also shows one or more of the sockets 542 and 544 has having a catch 550 that projects into a volume 551 defined by the socket 542 and 544. The catch 550 is adapted to retain the block of material 549 inserted into the socket 542 and/or 544. For example, the catch 550 can include a lip 552 positioned on the wall that helps define the socket 542 and/or 544. As the block of material 549 is inserted into the socket, the lip 552 and/or the block of material 549 can deflect (e.g., elastically deflect) to allow the block of material 549 to seat in the socket with the lip 552 positioned at least partially over a surface of the block of material 549. The socket 542 and/or 544 may include a slit or notch (as seen) to help the lip 552 to deflect as the block of material 549 is inserted into the socket 542 and/or 544. Once positioned at least partially over a surface of the block of material 549, the lip 552 helps to retain the block of material 549 in the socket 542 and/or 544.

FIG. 5 also provides an additional illustration where the first series of ribs 537 in the first fastening portion 533 extend (e.g., to enlarge the area of) longitudinally from the first end 504 of the first elongate beam 502 towards the second end of the first elongate beam 502. Similarly, the second series of ribs in the second fastening portion extend (e.g., to enlarge the area of) longitudinally from the second end of the first elongate beam towards the first end of the first elongate beam.

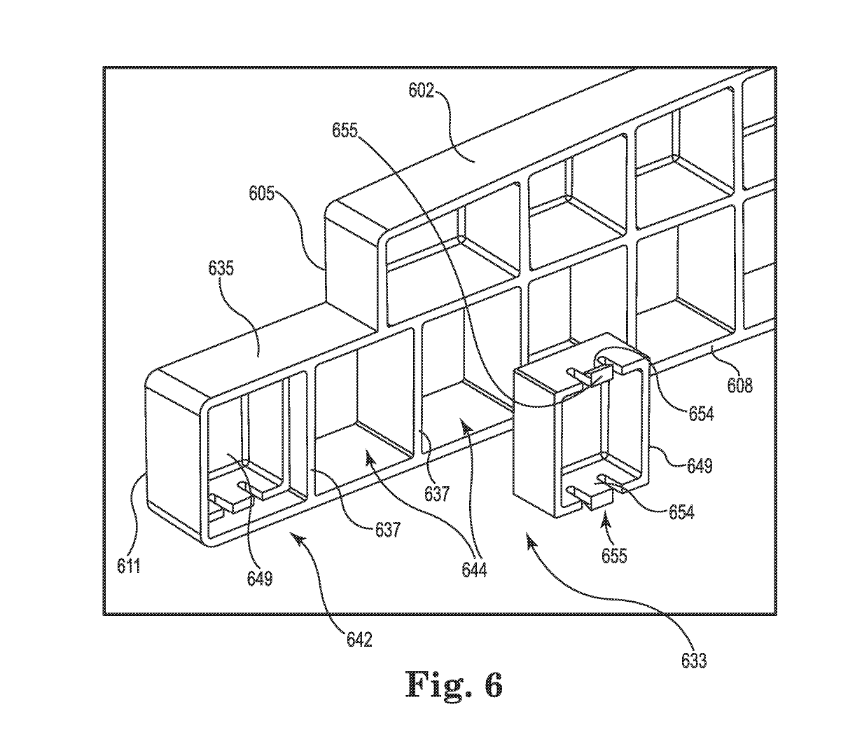

Referring now to FIG. 6, there is shown an enlarged view of the first fastening portion 633 having the socket 642 and 644, as discussed herein. The discussion for the first fastening portion 633 and the sockets 642 and 644 is applicable to the second fastening portion and its sockets, which are not shown in FIG. 6, but will be referenced in the following discussion. As illustrated, the socket 642 is defined at least in part by the first end wall 611 of the second elongate beam 608, at least a portion of the first ledge 635, at least a portion of the second elongate beam 608 and at least one rib of the first series of ribs 637. The second socket 644 is defined at least in part by two ribs of the first series of ribs 637, at least a portion of the second elongate beam 608 and at least a portion of the first ledge 635.

FIG. 6 shows an additional embodiment of the block of material 649. In this embodiment, the block of material 649 includes a lever 654 with a projection 655 that extends beyond the prevailing surface of the block of material 649. When the block of material 649 is inserted into the socket 642 and/or 644 the lever 654 deflects so as to force the projection 655 into the wall of the socket 642 and 644, thereby helping to hold and retain the block of material 649 in the socket 642 and 644.

The end wall structures (e.g., the first end wall and the second end wall at the end of each of the first elongate beam and the second elongate beam) are illustrated herein as having a contiguous planar surface. It is appreciated that there can be different shapes and configurations for the end wall structures. For example, while one or more of the end wall structures can have the contiguous planar surface, other end wall structures on the same one-piece polymeric composite rafter can have a different configuration. Examples of such a different configuration include, but are not limited to, surfaces that include one or more ledges and/or ridges that extend from a planar surface. In one embodiment, this configuration can occur when an end wall (e.g., 211 and/or 213 in FIG. 2A and 2B) is trimmed (e.g., removed) in shortening the length of the one-piece polymeric composite rafter, thereby leaving a rib 237 and portions of one or both of the first ledge 235 or the second ledge 236 and the second elongate beam 208 as the “new” end wall 211 and/or 213, respectively.

As illustrated in FIGS. 1A, 1B, 2A, 2B, 4A, and 4B, the “C-beam” shape is advantageous for a variety of reasons. For example, as seen in FIGS. 1A, 1B, 2A, 2B, 4A, and 4B, the web along with the edge of each of the first elongate beam and the second elongate beam provides a planar surface. This allows the one-piece polymeric composite rafter to have a substantially sized surface that can be aligned with other surfaces of the vehicle, where these surfaces can be aligned in a common plane. For example, the planar surface of the one-piece polymeric composite-rafter can be aligned with the vertical wall structure at either the front or rear of the vehicle, where the planar surface helps to present a contiguous planar surface on to which siding material for the vehicle can be more easily attached and/or applied. As illustrated, the planar surface defines an outer most portion of the perimeter of the one-piece polymeric composite rafter.

Besides the C-beam shape, other beam shapes for the one-piece polymeric composite rafter are possible. Examples of such beam shapes include, but are not limited to, an I-beam (or H-beam), hybrid I-beam, and hybrid C-beam, among others.

It is possible to adjust the thickness of the web along the longitudinal length of the one-piece polymeric composite rafter. For example, the web adjacent the truss structure has a first thickness and the web adjacent a first structural member and a second structural member can have a second thickness that is less than the first thickness. With respect to the thickness of the web, they can range from 3 millimeters (mm) to 6 mm. So, for example, the first thickness of the web (adjacent the truss structure) could be about 5 mm and the second thickness (adjacent the first structural member and the second structural member) could be about 3 mm. The transition from the first thickness to the second thickness could be a tapering transition. Alternatively, the transition from the first thickness to the second thickness could be a stepped transition. For example, the step could take place across a straight member (e.g., 5 mm thickness on one side of the straight member and 3 mm on the other side of the straight member). Intermediate thicknesses of the web between the first and second thicknesses are also possible.

Also illustrated in the FIGS. 1A, 1B, 2A, 2B, 4A, and 413, the truss structure and the straight members are provided in a pattern that helps to distribute a load that is transferred through the first elongate beam. The number, relative position and dimensions of the truss structure(s) and/or the straight members can be modified so as to meet the requirements of vehicle in which the one-piece polymeric composite rafter is to be used. In addition, the dimensions of the structural components of the one-piece polymeric composite rafter (e.g., the dimensions of the beams and the dimensions of the truss structure and/or the straight members) can each be individually adjusted and modified depending upon the specific strength and specific stiffness of the polymeric composite material used to form the one-piece polymeric composite rafter. Given the specific strength and specific stiffness, along with the specific gravity, of the polymeric composite material different designs of the one-piece polymeric composite rafter would be possible. The designs could then be tested with Finite Element Analysis software package, such as SOLIDWORKS™ 2011 Premium SIM software to see if they will meet the required and/or desired standards for the one-piece polymeric composite rafter.

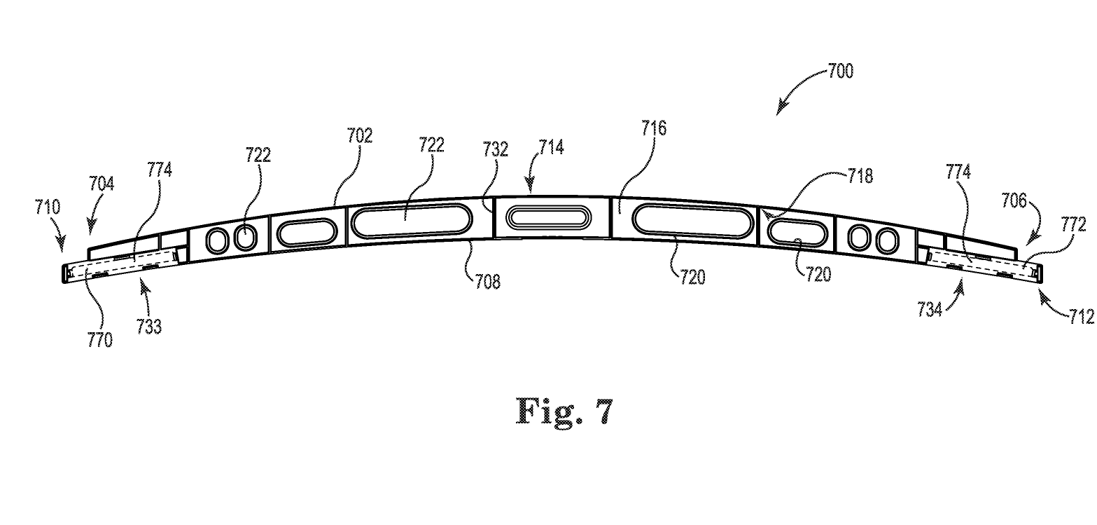

Referring now to FIG. 7, there is shown an additional embodiment of the one-piece polymeric composite rafter. The one-piece polymeric composite rafter 700 includes the first elongate beam 702 of the polymeric composite material, the first elongate beam 702 having the first end 704 and the second end 706. The composite rafter 700 further includes the second elongate beam 708 of the polymeric composite material, the second elongate beam 708 having a first end 710 adjacent the first end 704 of the first elongate beam 702 and the second end 712 adjacent the second end 706 of the first elongate beam 702.

As illustrated, the first elongate beam 702 and the second elongate beam 708 can each include the flange 714 that extends from the web 716. The first elongate beam 702, the second elongate beam 708 and the web 716 create a “C-beam” shape, where the web 716 extends from an edge 718, running in the longitudinal direction of the composite rafter 700, of each of the flanges 714. The web 716 of the composite rafter 700 further includes a surface 720 defining an opening 722 that passes through the web 716. The opening 722 allows for a variety of structures, as discussed herein, to pass through the composite rafter 700.

As mentioned, the composite rafter 700 also includes the first fastening portion 733 and the second fastening portion 734. In the embodiment of FIG. 7, the first fastening portion 733 includes a first structural member 770 and the second fastening portion 734 includes a second structural member 772. The first structural member 770 and the second structural member 772 are outlined in the first fastening portion 733 and the second fastening portion 734 with a broken line in FIG. 7. Each of the first structural member 770 and the second structural member 772 is formed of a material that is different than the polymeric composite material, and each has a coating 774 of the polymeric composite material that that at least partially surrounds the first structural member 770 and the second structural member 772. The coating 774 over at least a portion of the first structural member 770 and the second structural member 772 provide at least a portion of the planar surface, as discussed herein.

The first structural member 770 can be located adjacent the first end 704 and 710 of both the first elongate beam 702 and the second elongate beam 708. The second structural member 772 can be located adjacent the second end 706 and 712 of both the first elongate beam 702 and the second elongate beam 708. Each of the first structural member 770 and the second structural member 772 is formed from a material that is different than the polymeric composite material used in the composite rafter 700 (e.g., the first elongate beam 702 and the second elongate beam 708, the coating 774, etc.). The first structural member 770 and the second structural member 772 can be formed from a variety of different materials. For example, the first structural member 770 and the second structural member 772 can be at least partially, or completely, formed from wood and/or a synthetic polymer. Examples have been provided herein. For the various embodiments, the coating 774 helps to prevent splitting and/or fracturing of the first structural member 770 and/or the second structural member 772 when a fastener (e.g., a nail, a screw) as discussed herein, is driven into the structural member 770 and/or 772.

As discussed herein, the polymeric composite material of the present disclosure can be formed from a polyolefin, a long glass fiber reinforcement and a coupling agent. Specifically, the polymeric composite material includes 47 weight percent (wt. %) to 89.5 wt. % of the polyolefin, 10 wt. % to 50 wt. % of a long glass fiber reinforcement and 0.5 wt. % to 3 wt. % of the coupling agent, which can react to couple the long glass fiber reinforcement to the polyolefin. The wt. % values of the polymeric composite material are based on a total weight of the polymeric composite material. The weight percent of the polyolefin, the long glass fiber reinforcement and the coupling agent used in forming the polymeric composite material total to a value of 100 wt. %. For the various embodiments, the first elongate beam, the second elongate beam, the first fastening portion and the second fastening portion are formed as the one-piece polymeric composite rafter from the polymeric composite material.

Examples of suitable polyolefins for the present disclosure include, but are not limited to, polypropylene, polyethylene, polyamide (e.g., nylon, such as nylon 6; nylon 6,6; nylon 12, etc.), polyesters, polyurethanes, acrylonitrile butadiene styrene, polycarbonate, polystyrene, among others. Copolymers, terpolymers, and blends of these polymers may also be used. Examples of such polyolefins can also include “recycled” polyolefins, such as recycled polypropylene. The polyolefins for the present disclosure can also be copolymers (e.g., heterophasic copolymers, random copolymers, block-copolymers) formed with propylene and ethylene monomers. It is also possible to include a plastomer with the polyolefin or the copolymer, where examples of such plastomers include, but are not limited to butene or octene. It is also possible to use polyethylene terephthalate (e.g., textile grades in particular). Different polyolefins may be used for various structural components. Blends of polyolefins with other compatible thermoplastics or with elastomeric tougheners such as elastomeric polymers of styrene, butadiene, alkyl acrylates, and the like may also be useful. Preferably, the polyolefin of the present disclosure is polypropylene.

Preferably, the polyolefin of the present disclosure can have a melt flow index (MFI) from 0.5 to 500 as measured according to ASTM D1238. More specifically, the polyolefin can have a MFI from 12 to 140 as measured according to ASTM D1238. Most preferably, the polyolefin can have a MFI from 30 to 50 as measured according to ASTM D1238. In one embodiment, the MFI of the polyolefin is 30 as measured according to ASTM D1238.

As used herein, long glass fiber reinforcement includes fiberglass that has a mean average length from 0.5 cm to 2.5 cm. It is also appreciated that the long glass fiber reinforcement could be introduced as a fiberglass roving (e.g., in a direct long fiber thermoplastic process as discussed herein) into the mixing process, whereby the fiberglass roving is chopped, or broken apart, during the mixing process so as to achieve glass fibers having mean average length from 0.5 cm to 2.5 cm. Preferably, the long glass fiber reinforcement has a mean average length of 1.0 cm to 1.5 cm.

For the various embodiments, the long glass fiber reinforcement can have a variety of structural grades. For example, the long glass fiber reinforcement can be an Electrical-grade (E-grade) prechopped fiberglass. Other grades are also possible, such as S-grade or S2-grade among others.

The long glass fiber reinforcement can have an aspect ratio in a range from 150 to 700 (mean average) when added during the compounding of the polymeric composite material. Preferably, the long glass fiber reinforcement can have an aspect ratio in a range of 400 to 700 (mean average) when added during the compounding of the polymeric composite material. In one embodiment, the long glass fiber reinforcement can have an aspect ratio of 700 (mean average) when added during the compounding of the polymeric composite material. It is appreciated that the aspect ratio of the long glass fiber reinforcement can change (e.g., decrease) during the compounding of the polymeric composite material in the mixer(s) (e.g., the extruder).

It is further appreciated that the long glass fiber may also include a sizing agent (e.g., has a sizing agent on its surface). A variety of sizing agents are possible, where the selection of the sizing agent can be dependent upon the matrix (e.g., polymer matrix) into which the long glass fiber reinforcement will be used. This sizing agent, if present on the long glass fiber, is considered to be different than the coupling agent of the present disclosure. Specifically, regardless of a sizing agent being present on the long glass fiber, or not being present, the present disclosure separately adds the coupling agent to the polymeric composite material of the present disclosure.

As provided herein, the coupling agent is a component of the polymeric composite material that is added separately from the other components used in forming the polymeric composite material. As used herein a coupling agent is a chemical compound added independent of the long glass fiber reinforcement, where the coupling agent is capable of reacting with and covalently joining both the long glass fiber reinforcement and the polyolefin. Preferably, among other suitable coupling agents, the coupling agent is maleic anhydride (furan-2,5-dione).

In a preferred embodiment of the polymeric composite material the polyolefin is polypropylene and the coupling agent is maleic anhydride.

As discussed herein, the polymer composite material has a hardness that allows for fasteners to be secured to the one-piece polymeric composite rafter of the present disclosure Examples of such fasteners include, but are not limited to, mechanical fasteners such as nails, screws, staples, pins and tacks. To facilitate the use of such mechanical fasteners the polymeric composite material has Shore-D hardness of about 74 as tested according to ASTM D2240.

Examples of other fasteners include reactive adhesives and non-reactive adhesives. Examples of such adhesives include, but are not limited to, drying adhesives, pressure sensitive adhesives, contact adhesives, hot melt adhesives, multi-part adhesives, one-part adhesives, insulating foam sealants, natural adhesives and synthetic adhesives.

The surface of the one-piece polymeric composite rafter may need to be prepared prior to receiving the adhesive. Examples of preparing the surface of the one-piece polymeric composite rafter can include, but are not limited to, mechanically and/or chemically modifying the surface (e.g., roughening the surface texture) of the one-piece polymeric composite rafter. This can be done, for example, by using a grinding wheel and/or sandpaper, and/or by heating the surface to slightly change the surface composition (e.g., to slightly char the surface).

It is also possible that the polymeric composite material of the present disclosure can have a flame retardant. For example, the polymeric composite material of the present disclosure can optionally have up to 60 wt. % of a flame retardant, where the wt. % values of the polymeric composite material are based on a total weight of the polymeric composite material and total to a value of 100 wt. %.

Examples of suitable flame retardants for the polymeric composite material include, but are not limited to, mineral based flame retardants such as, but not limited to, magnesium hydroxide, aluminum hydroxide, alumina trihydrate, hydromagnesite, zinc borate, and combinations thereof Preferably, the flame retardant for the polymeric composite material is magnesium hydroxide. The flame retardant can have a mean average particle size in a range of 3 to 6 μm. Preferably the flame retardant has a mean average particle size of 4.5 μm. Other known flame retardants are also possible (e.g, heat suppression agents and char formers).

The polymeric composite material of the present disclosure can also include a variety of additional additives. For example, the polymeric composite material can include a color additive. Examples of a suitable color additive include a color concentrate in solid form that includes an olefinic carrier base resin and carbon black. Alternatives could be a form of pigmentation that will result in a part appearing black. Dosing of the base material using a liquid or a dry powder delivery system could be considered alternatives to coloring the polymeric composite material.

The polymeric composite material of the present disclosure can also include a filler. Examples of suitable fillers include, but are not limited to, carbon fiber, aramid fiber, natural fiber, talc, calcium carbonate, mica, wollastonite, milled fiberglass, and fiberglass solid spheres, and fiberglass hollow spheres, nepheline syenite and combinations thereof. The use of a filler can help to provide fire resistance through pure mass replacement with a non-combustible filler.

The polymeric composite material of the present disclosure can be compounded in a mixing process. Examples of suitable devices for the mixing process can include, but are not limited to, screw extruders or a Banbury mixer. Examples of suitable screw extruders include those with a single or a double screw, where the extruder can include, if desired, a breaker plate and corresponding screen pack. A series of two screw extruders can be used in forming the polymeric composite material of the present disclosure. For example a first screw extruder can be used to melt blend the polyolefin, the coupling agent and, optionally, a flame retardant. The content of the first screw extruder can be introduced into the second screw extruder along with the long glass fiber reinforcement. Examples of such mixing processes are found in U.S. Pat. Nos. 5,165,941 and 5,185,117, both to Hawley, which are incorporated herein in their entirety.

The polymeric composite material discussed herein can be extruded from the mixing process and then molded into the one-piece polymeric composite rafter of the present disclosure. It is also possible to use a direct long fiber thermoplastic process technique in forming and extruding the polymeric composite material of the present disclosure. Molding techniques used in molding the one-piece polymeric composite rafter include, but are not limited to, injection molding or transfer molding.

For the various embodiments, the method of forming the one-piece polymeric composite rafter of the present disclosure can include extruding the polymeric composite material, as discussed herein. A mold having a cavity that defines the shape and volume of the one-piece polymeric composite rafter is provided herein. Upon closing the mold, the polymeric composite material is injected into the cavity of the mold to form the one-piece polymeric composite rafter.

The mold can include one or more inserts and/or structures that allow for forming the series of ribs in the first fastening portion and the second fastening portion. So, for example, the series of ribs in the first fastening portion and the second fastening portion can help to form a socket in each of the first fastening portion and the second fastening portion. Once formed, a block of material can be inserted into the socket in each of the first fastening portion and the second fastening portion, as discussed herein. For example, it is possible to insert the block of material into a socket shortly after the one-piece polymeric composite rafter has been released from the mold (before it reaches ambient temperature) and/or after the one-piece polymeric composite rafter has reached ambient temperature.

It is also possible to use one or more inserts and/or structures in the cavity of the mold to help define the length of the one-piece polymeric composite rafter. For example, the cavity of the mold could be shaped to form the one-piece polymeric composite rafter having a first length (e.g., as measured between the first end and the second end of the second elongate beam). One or more inserts could be fit into the ends of the cavity of the mold that would change (e.g., shorten) the first length of the one-piece polymeric composite rafter.

As discussed herein, the one-piece polymeric composite rafter (e.g., 100, 200, 400 and/or 700) can have dimensions that are suitable for use as a rafter in a vehicle. As illustrated, the one-piece polymeric composite rafter can have a length as measured between the first end and the second end of the second elongate beam that is suitable for the vehicle in which the one-piece polymeric composite rafter will be used. As discussed herein, while the length may be suitable for the vehicle in which the one-piece polymeric composite rafter will be used, it may be necessary to “trim” the length to better fit the one-piece polymeric composite rafter to the vehicle. As discussed herein, the first fastening portion and the second fastening portion can be “trimmed” and/or cut (e.g., shaped) to provide the one-piece polymeric composite rafter with a length that is appropriate for a given vehicle.

For example, the one-piece polymeric composite rafter can be formed having a length of 96 inches as measured between the first end and the second end of the second elongate beam (other lengths are of course possible). If necessary, at least a portion of the first fastening portion and the second fastening portion can be removed (e.g., trimmed) to change (e.g., shorten) the length and/or the shape of the first fastening portion and the second fastening portion. This trimming, shaping and/or modifying can be accomplished with a number of different hand and/or power tools. Such hand and/or power tools include, but are not limited to, saws (e.g., circular saw, reciprocal saw, hand saw, hacksaw, miter saw), routers, drills, sanders (e.g., belt sander, circular sander), and grinders, among other known tools used to shape and/or cut material.

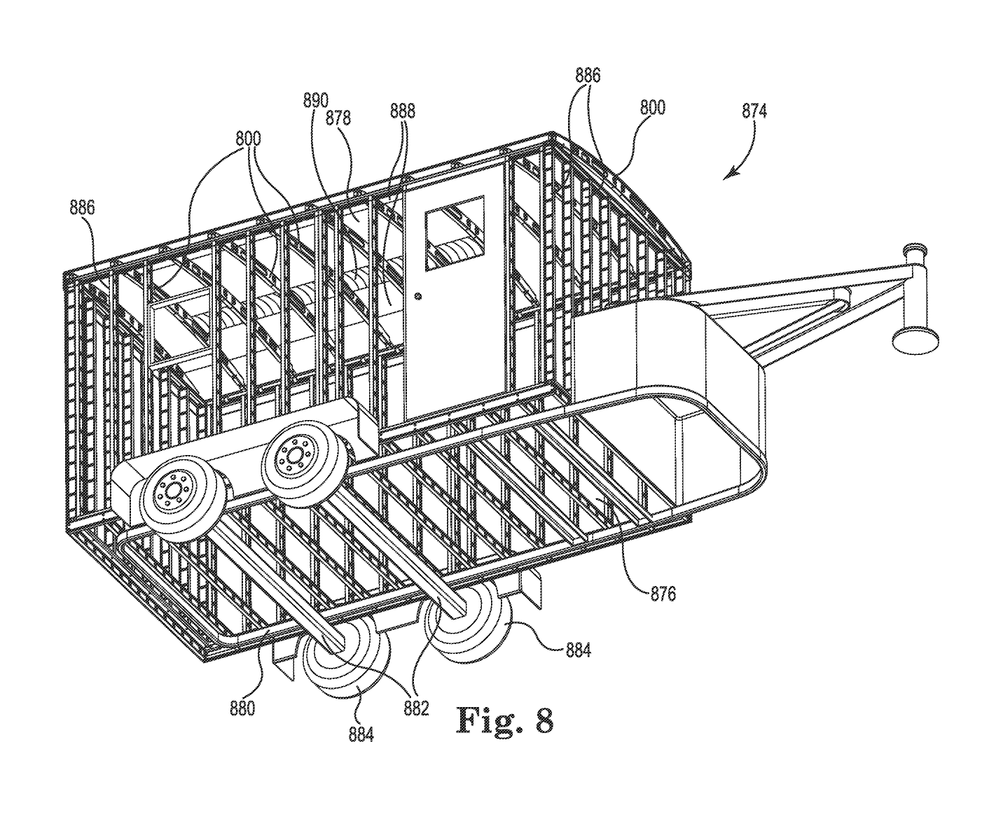

As discussed herein, the one-piece polymeric composite rafter of the present disclosure helps support a roof of the vehicle. Referring now to FIG. 8, there is illustrated a vehicle 874 that includes the one-piece polymeric composite rafter 800 of the present disclosure. The vehicle 874 is shown with an exterior siding 876 and a roof 878. In addition to the exterior siding 876 and the roof 878 (e.g., roof deck and overlayment), the vehicle 874 also includes a frame 880, an axle 882 joined to the frame 880 and wheels 884 joined to the axle 882, where the wheels 884 can turn relative the axle 882. The vehicle 874 also includes a vertical wall structure 886 projecting from the frame 880, where the exterior siding 876 can be attached to the vertical wall structure 886.

As each vehicle 874 may have variation in position of the vertical wall structure 886 and/or the exterior siding 876, the one-piece polymeric composite rafter 800 of the present disclosure allows for a custom fit to the vertical wall structure 886 and/or the exterior siding 876. Specifically, one or both of the first fastening portion and the second fastening portion can be shaped to allow the one-piece polymeric composite rafter 800 to be joined to the vertical wall structure 886 (e.g., modified to provide a desired shape in relation to the vertical wall structure 886).

As illustrated, the one-piece polymeric composite rafter 800 projects from the vertical wall structure 886 to support the roof 878 of the vehicle 874. The first fastening portion and the second fastening portion allow for fasteners, as discussed herein, to be used to join the one-piece polymeric composite rafter 800 to the vertical wall structure 886. For example, a screw can be used to join the vertical wall structure 886 to the one-piece polymeric composite rafter 800, where the threaded shaft of the screw can cut a helical groove into the first fastening portion and/or the second fastening portion. A nail could also be used to join the vertical wall structure 886 to the one-piece polymeric composite rafter 800, where the shaft of the nail can be driven into the first fastening portion and/or the second fastening portion. As illustrated, the opening through the one-piece polymeric composite rafter 800 allows for such things as electrical wiring 888 and ventilation ducts 890 passing through the opening in the one-piece polymeric composite rafter 800.

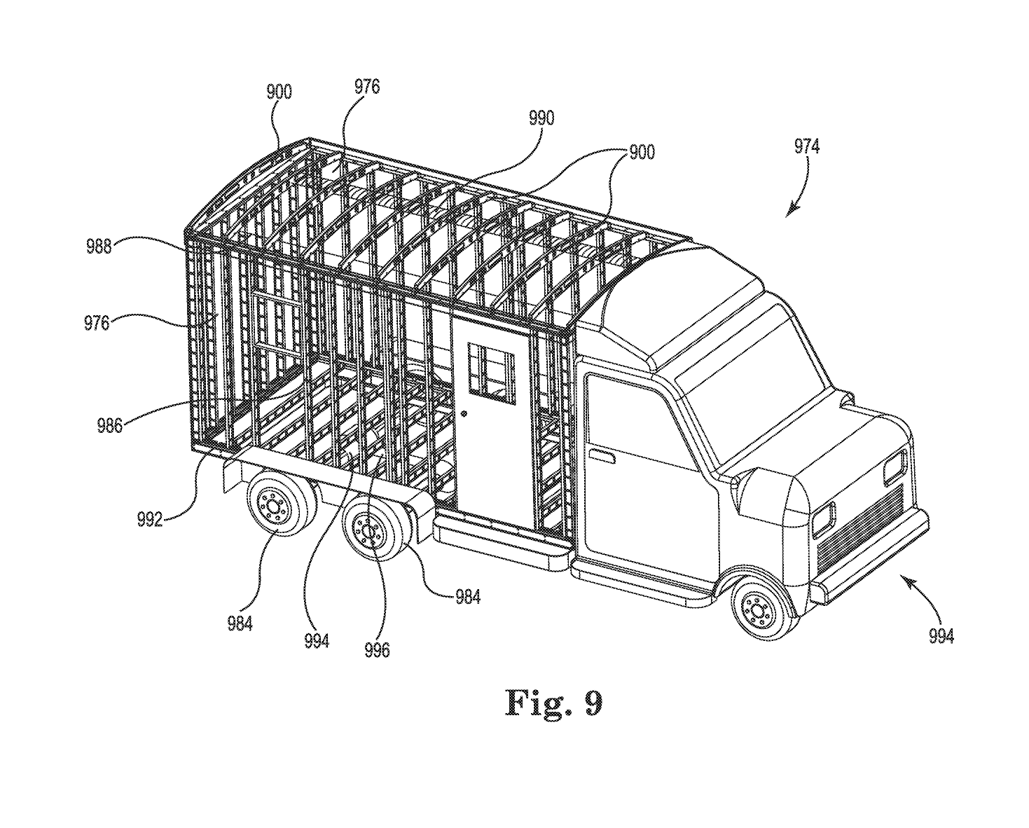

FIG. 9, there is shown an embodiment of the vehicle 974 that includes the one-piece polymeric composite rafter 900 of the present disclosure. The vehicle 974 is shown with exterior siding 976 and a roof, which has been removed to better illustrate the position of the one-piece polymeric composite rafter 900. In addition to the exterior siding 976 and the roof (e.g., roof deck and overlayment), the vehicle 974 also includes a frame 992, a motor 994 mounted to the frame 992, an axle 994 joined to the frame 992 and wheels 984 joined to the axle 994, a transmission 996 mounted to the frame 992 and coupled to the motor 480 and the axel 994 to allow the motor 994 to turn the wheels 984 relative the axle 994. The vehicle 974 also includes a vertical wall structure 986 projecting from the frame 992, where the exterior siding 976 can be attached to the vertical wall structure 986. In one embodiment, the vehicle 974 is a recreational vehicle, also known as an “RV.”

As each vehicle 974 may have variation in position of the vertical wall structure 986 and/or the exterior siding 976, the one-piece polymeric composite rafter 900 of the present disclosure allows for a custom fit to the vertical wall structure 986 and/or the exterior siding 976. Specifically, one or both of the first fastening portion and the second fastening portion can be shaped to allow the one-piece polymeric composite rafter 900 to be joined to the vertical wall structure 986 (e.g., modified to provide a desired shape in relation to the vertical wall structure 986).

As illustrated, the one-piece polymeric composite rafter 900 projects from the vertical wall structure 986 to support the roof of the vehicle 974. The first fastening portion and the second fastening portion allow for fasteners, as discussed herein, to be used to join the one-piece polymeric composite rafter 900 to the vertical wall structure 986. For example, a screw can be used to join the vertical wall structure 986 to the one-piece polymeric composite rafter 900, where the threaded shaft of the screw can a helical groove into the first fastening portion and/or the second fastening portion. A nail could also be used to join the vertical wall structure 986 to the one-piece polymeric composite rafter 900, where the shaft of the nail can be driven into the first fastening portion and/or the second fastening portion. As illustrated, the opening through the one-piece polymeric composite rafter 900 allows for such things as electrical wiring 988 and ventilation ducts 990 passing through the opening in the one-piece polymeric composite rafter 900.

The above specification, examples and data provide a description of the present disclosure. Since many examples can be made without departing from the spirit and scope of the present disclosure, this specification merely sets forth some of the many possible example configurations and implementations.

1. A one-piece polymeric composite rafter, comprising:
a first elongate beam having a first end and a second end, where the first end includes a first end wall and the second end includes a second end wall;
a second elongate beam having a first end adjacent the first end of the first elongate beam and a second end adjacent the second end of the first elongate beam, where the first end includes a first end wall and the second end includes a second end wall;
a first fastening portion having a first ledge projecting between the first end wall of the first elongate beam and the first end wall of the second elongate beam, where the first fastening portion projects longitudinally beyond the first end of the first elongate beam towards the first end of the second elongate beam; and
a second fastening portion having a second ledge projecting between the second end wall of the first elongate beam and the second end wall of the second elongate beam, where the second fastening portion projects longitudinally beyond the second end of the first elongate beam towards the second end of the second elongate beam and where the first elongate beam, the second elongate beam, the first fastening portion and the second fastening portion are formed as the one-piece polymeric composite rafter from a polymeric composite material having:
47 weight percent (wt. %) to 89.5 wt. % of a polyolefin;
10 wt. % to 50 wt. % of a long glass fiber reinforcement; and
0.5 wt. % to 3 wt. % of a coupling agent coupling the long glass fiber reinforcement to the polyolefin, wherein the wt. % values of the polymeric composite material are based on a total weight of the polymeric composite material and total to a value of 100 wt. %.

2. The one-piece polymeric composite rafter of claim 1, where the polyolefin is polypropylene and the coupling agent is maleic anhydride.

3. The one-piece polymeric composite rafter of claim 1, where the polymeric composite material has Shore-D hardness of about 74 as tested according to ASTM D2240.

4. A one-piece polymeric composite rafter formed from a polymeric composite material, comprising:
a first elongate beam having a first end and a second end, where the first end includes a first end wall and the second end includes a second end wall;
a second elongate beam having a first end adjacent the first end of the first elongate beam and a second end adjacent the second end of the first elongate beam, where the first end includes a first end wall and the second end includes a second end wall;
a first fastening portion having a first ledge projecting between the first end wall of the first elongate beam and the first end wall of the second elongate beam, and a first series of ribs in which each rib projects in a direction between the first elongate beam and the first ledge, where the first fastening portion projects longitudinally beyond the first end of the first elongate beam towards the first end of the second elongate beam; and
a second fastening portion having a second ledge projecting between the second end wall of the first elongate beam and the second end wall of the second elongate beam, and a second series of ribs in which each rib projects in a direction between the first elongate beam and the second ledge, where the second fastening portion projects longitudinally beyond the second end of the first elongate beam towards the second end of the second elongate beam, where the first series of ribs and the second series of ribs are adapted to receive and secure a fastener.

5. The one-piece polymeric composite rafter of claim 4, where the first fastening portion includes a socket defined at least in part by the first end wall of the second elongate beam, at least a portion of the first ledge, at least a portion of the second elongate beam and at least one rib of the first series of ribs.

6. The one-piece polymeric composite rafter of claim 5, where the first fastening portion includes a second socket defined at least in part by two ribs of the first series of ribs, at least a portion of the second elongate beam and at least a portion of the first ledge.

7. The one-piece polymeric composite rafter of claim 5, where at least one of either the first end wall, the portion of the first ledge, the portion of the second elongate beam or the at least one rib includes a catch that projects into a volume defined by the socket, where the catch is adapted to retain a block of material inserted into the socket.

8. The one-piece polymeric composite rafter of claim 4, where the second fastening portion includes a socket defined at least in part by the second end wall of the second elongate beam, at least a portion of the second ledge, at least a portion of the second elongate beam and at least one rib of the second series of ribs.

9. The one-piece polymeric composite rafter of claim 8, where the second fastening portion includes a second socket defined at least in part by two ribs of the second series of ribs, at least a portion of the second elongate beam and at least a portion of the second ledge.

10. The one-piece polymeric composite rafter of claim 8, where at least one of either the second end wall, the portion of the second ledge, the portion of the second elongate beam or the at least one rib includes a catch that projects into a volume defined by the socket, where the catch is adapted to retain a block of material inserted into the socket.

11. The one-piece polymeric composite rafter of claim 4, where the series of ribs defining the first fastening portion also project longitudinally from the first end of the first elongate beam towards the second end of the first elongate beam.

12. The one-piece polymeric composite rafter of claim 4, where the series of ribs defining the second fastening portion also project longitudinally from the second end of the first elongate beam towards the first end of the first elongate beam.

13. (canceled)

14. The one-piece polymeric composite rafter of claim 4, where the polymeric composite material includes:
47 weight percent (wt. %) to 89.5 wt. % of a polyolefin;
10 wt. % to 50 wt. % of a long glass fiber reinforcement; and
0.5 wt. % to 3 wt. % of a coupling agent coupling the long glass fiber reinforcement to the polyolefin, wherein the wt. % values of the polymeric composite material are based on a total weight of the polymeric composite material and total to a value of 100 wt. %.

15. The one-piece polymeric composite rafter of claim 14, where the polyolefin is polypropylene and the coupling agent is maleic anhydride.

16. A method of forming a one-piece polymeric composite rafter, comprising:
extruding a polymeric composite material; and
molding the polymeric composite material in a cavity of a mold to form the one-piece polymeric composite rafter having:
a first elongate beam with a first end and a second end, where the first end includes a first end wall and the second end includes a second end wall;
a second elongate beam having a first end adjacent the first end of the first elongate beam and a second end adjacent the second end of the first elongate beam, where the first end includes a first end wall and the second end includes a second end wall;
a first fastening portion having a first ledge projecting between the first end wall of the first elongate beam and the first end wall of the second elongate beam, and a first series of ribs in which each rib projects in a direction between the first elongate beam and the first ledge, where the first fastening portion projects longitudinally beyond the first end of the first elongate beam towards the first end of the second elongate beam; and
a second fastening portion having a second ledge projecting between the second end wall of the first elongate beam and the second end wall of the second elongate beam, and a second series of ribs in which each rib projects in a direction between the first elongate beam and the second ledge, where the second fastening portion projects longitudinally beyond the second end of the first elongate beam towards the second end of the second elongate beam, where the first series of ribs and the second series of ribs are adapted to receive and secure a fastener.

17. The method of claim 16, including forming a socket in each of the first fastening portion and the second fastening portion; and
inserting a block of material into the socket in each of the first fastening portion and the second fastening portion.

18. The method of claim 16, including removing at least a portion of the first fastening portion and at least a portion of the second fastening portion so that a rib of the first series of ribs and a rib of the second series of ribs defines a peripheral surface of the one-piece polymeric composite rafter.

19. The method of claim 16, where extruding the polymeric composite material includes extruding the polymeric composite material having:
47 weight percent (wt. %) to 89.5 wt. % of a polyolefin;
10 wt. % to 50 wt. % of a long glass fiber reinforcement; and
0.5 wt. % to 3 wt. % of a coupling agent coupling the long glass fiber reinforcement to the polyolefin, wherein the wt. % values of the polymeric composite material are based on a total weight of the polymeric composite material and total to a value of 100 wt. %.

20. The method of claim 16, including projecting the series of ribs defining the first fastening portion longitudinally from the first end of the first elongate beam towards the second end of the first elongate beam.

21. The method of claim 16, including projecting the series of ribs defining the second fastening portion longitudinally from the second end of the first elongate beam towards the first end of the first elongate beam.
